(19) United States
(12) Patent Application Publication
(10) Pub. No.: US 2011/0105157 A1
(43) Pub. Date: May 5, 2011

(54) SMS Communication Platform and Methods for Telematic Devices

(76) Inventors: Binh Ke Nguyen, Naperville, IL (US); Emad S. Isaac, Downers Grove, IL (US)

(21) Appl. No.: 12/608,459

(22) Filed: Oct. 29, 2009

(51) Int. Cl. H04W 4/12

(52) U.S. Cl. 455/466

(57) ABSTRACT

The present disclosure generally relates to a bidirectional communication platform using short message communication with a telematics device for remotely updating parameters of the device, for obtaining reports and other information regarding the parameters of the device, and to upload control data and specific data to the device. More specifically, a software adaptation layer is added to a telematics device to bidirectionally communicate with receiver and emitter cell phones.

### FIELD OF THE DISCLOSURE

The present disclosure generally relates to a bidirectional communication platform using short message communications to communicate with a telematics device for remotely updating parameters of the device, for obtaining reports and other information regarding the parameters of the device, and to upload control data and specific data onto the device.

### BACKGROUND

Telematics is the integrated use of telecommunications and informatics, also known generally as Information and Communication Technology. Telematics is the science of sending, receiving and storing information via telecommunication devices. Recently, because of the arrival of the Global Positioning System, telematics is often also applied specifically to navigational systems placed onboard vehicles with integrated computers and mobile communication systems. Within the scope of this disclosure, the term telematics is to be construed broadly to include land based asset tracking devices, vehicle tracking technology, fleet management control, satellite navigation, mobile data and mobile television telecommunication in vehicles, wireless vehicle safety communications, emergency warning onboard systems in vehicles, intelligent vehicle technologies, or even automate vehicle related services linked with vehicle movement.

FIG. 1 shows one device from the prior art where a telematics device is located onboard a vehicle shown as a car. The vehicle includes a wireless communicator in communication with a wireless carrier system who is ultimately connected to a call center. The car driver, as in the case of the ONSTAR® system, pushes a button and is linked wirelessly with a call center shown by the large box at the bottom of the illustration. ONSTAR® is also equipped with a capacity to automatically call a call center in case of a crash (e.g. when accelerometer values exceed a value, when the airbag deploys, or when the vehicle speed drops perspicuously).

The call center includes an automated speech recognition system and other data devices to communicate with the vehicle using a land network, a communication network, and a short message service center. The problem with this device is the necessity of a user to be in the vehicle. The use of a voice activates the platform in order to obtain useful information back from the call center. The onboard telematics device is a passive element of the system in this overall platform of communication between a user and a call center.

Some telematics devices travel autonomously or travel without a close proximity user. For example, small telematics tracers are hidden away on new currency transported to local banks Telematics devices are also used to track movements of a fleet of vehicles, boats, and other vehicles. Telematics devices can often be hard to reach on top of towers, basements, on rooftops, and the like.

Telematics devices are computers with onboard memory and software operating within the memory. These devices also need to be serviced or accessed at regular intervals for upgrades of software, maintenance, to download stored information, access collected data, modify parameters, or collect test results when the telematics device is in test phase. To download the information, a hard wired connection via a port external to the device is accessed. A laptop, for example, can be used with a USB cable connected to a USB port on the telematics device. When the devices are difficult to access, the download and collection of data can be problematic. When data must be collected from a network of telematics devices, the collection process can be very burdensome. What is needed is a new method for collecting stored information on the telematics device, and interacting with the telematics device.

Telematics devices are equipped with a software layer in a processing space, and some type of wireless communication interface linked functionally to the processing space for communication with the external world. After data is collected from the telematics device, a software layer is used to conduct data processing before it is sent to users. For example, test data, based on the data acquired may be sent and manipulated more frequently, or may need to reach different users. What is needed is a method and a platform for sending specific data to specific recipients. What is also needed is a system to manipulate configuration parameters locally using the telematics device software interface.

### SUMMARY

The present disclosure generally relates to a bidirectional communication platform using short message communications with a telematics device for remotely updating parameters of the device, for obtaining reports and other information regarding the parameters of the device, and to upload control data and specific data to the device. More specifically, a software adaptation layer is added to a telematics device to bidirectionally communicate with receiver and emitter cell phones.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is an illustration of a device from the prior art.

FIG. 2 is a call flow diagram from a first device originating a short message to a terminal receiving the message from the prior art.

FIG. 3 is a functional diagram of the SMS communication platform for telematics devices according to an embodiment of the present disclosure.

FIG. 4 is a second functional diagram of the user interaction with the SMS communication platform according to another embodiment of the present disclosure.

FIG. 5 is a functional illustration of the telematics device within the SMS communication platform according to an embodiment of the present disclosure.

FIG. 6 is a diagram of a method for collecting information from a telematics device and a method for sending control data to a telematics device according to an embodiment of the present disclosure.

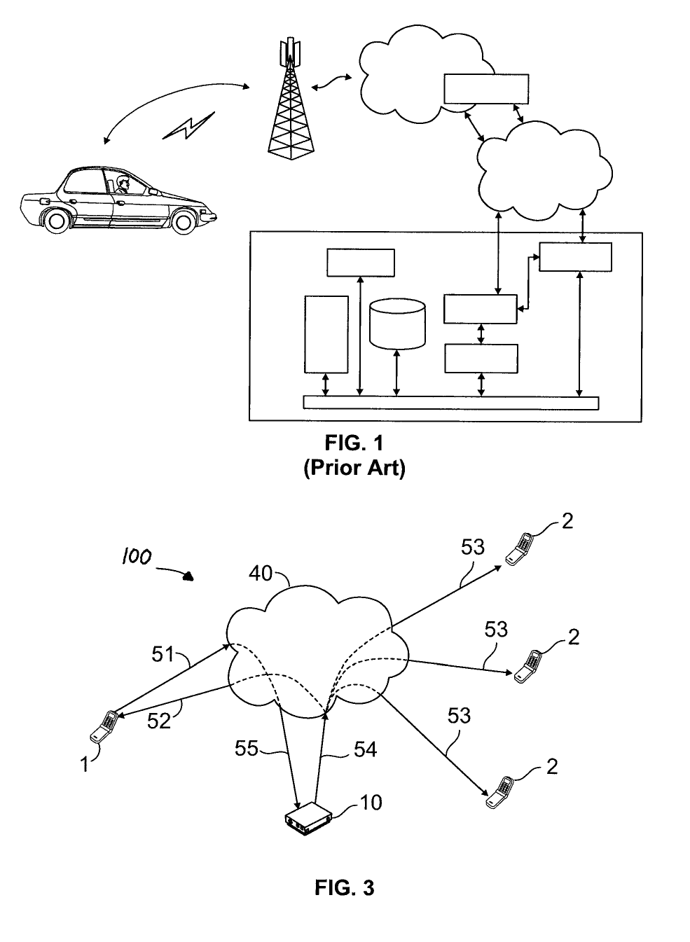

### DETAILED DESCRIPTION OF THE INVENTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

Telematics devices are integrated informatics and telecommunication devices capable of remote communication. As part of the Global System for Mobile (GSM) communications, technology like Short Message Service (SMS) has been developed. SMS is a communication service standardized in the GSM mobile communication system, using standardized communications protocols to allow the exchange of short text messages between mobile telephone devices. The latest GSM and SMS technical specification is described in 3GPP TS 23.041 v.7.0.0 (2006-03) “3rd Generation Partnership Project; Technical Specification Group Terminals; Technical realization of Cell Broadcast Service (CBS)(Release 7). While the SMS system as part of the GSM network is described, what is contemplated is the application of this disclosure in relation with any short message system.

SMS messages are short strings of characters sent from one device to the next using either SMS Point-to-Point Mobile Terminal (SMS-MT) where the message can be sent by phone or by a software application in a telematics device, a Point-to-Point Mobile Oriented (SMS-MO) where the message is sent to a phone or to a software application, or Short Message Cell Broadcast (SMS-CB). Original SMS messages are up to 160 characters long. The third generation of SMS allows for longer messages to be sent but trumped into smaller segments during delivery.

What is also contemplated is the use of Enhanced Messaging Service (EMS) known as an application-level extension to Short Message Service (SMS) for cellular phones available on GSM, TDMA, CDMA, and OFDM networks. The EMS is designed to transfer more than a string of characters and may include special text formatting such as bold and italics, animations, pictures, icons, sound effects and special ring tones. EMS is defined for example in the 3GPP Technical Specification 23.040 “Technical realization of Short Message Service (SMS).” The new EMS standard is also defined as the SMS 2 technologies in some circles.

In another embodiment, what is also contemplated is the use of the Multimedia Messaging Service (MMS) as a telecommunications standard for sending messages that include multimedia objects such as images, audio, video, rich text, etc. MMS is an extension of SMS that allows for the use of longer messages thought the Wireless Application Protocol (WAP) interface browser located in the portable communication device.

While the term SMS is used, what is contemplated as SMS is the use of any short messaging system including but not limited to SMS, EMS, SMS 2, MMS, or the like. In yet another embodiment, the use of Secure SMS Messaging Protocol is contemplated such as SafeSMS, SSMS, or SMSSec for an end-to-end security at the application layer to reinforce the SMS technology protocol. Other secure systems such as encryption of the messages themselves is contemplated. For example the use of SecureSMS™ from CellTrust Corporation.

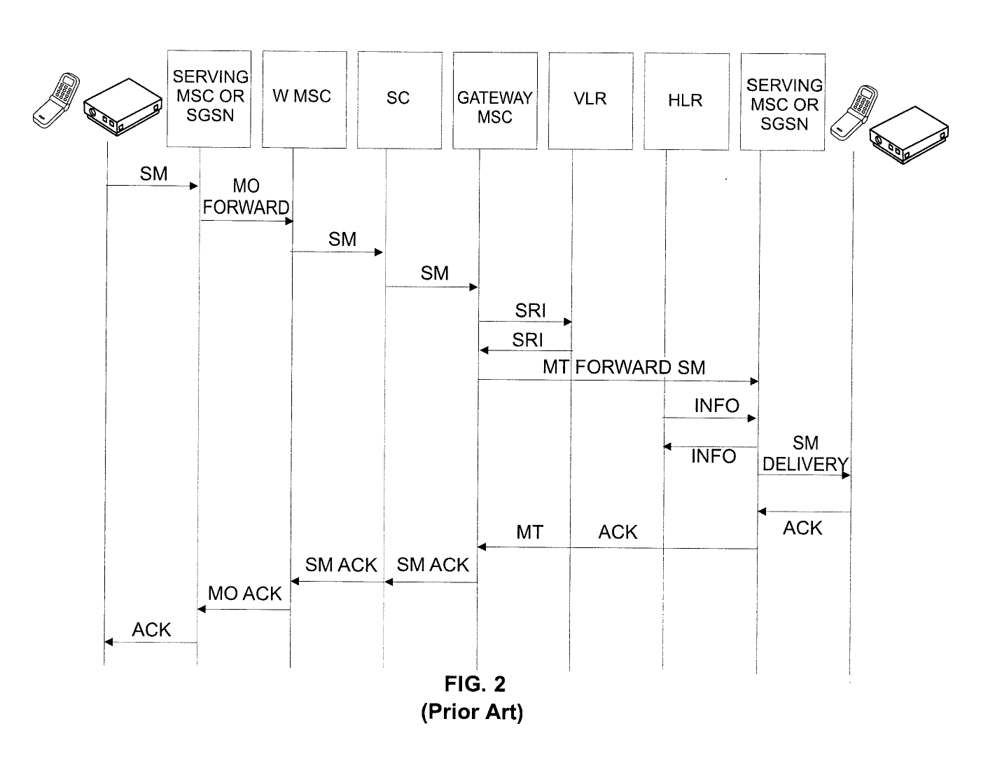

Using the SMS communication protocol, positive confirmation that a message sent has reached the intended recipient can be obtained either by a software layer programming of the recipient unit or by using coded characters such as, for example, *0# or *N# before the beginning string of characters in the message sent to the recipient unit. This system of confirmation messages as shown on FIG. 2 as part of the prior art SMS 3GPP technology is illustrated by a series of arrows from left to right and back to the left to illustrate the delivery of a SMS message under the default “forward and forget” option of the Short Message Service Center (SMSC) or the “best effort” delivery system of the protocol. Finally, in yet another embodiment, the GSM 03.41 defines Short Message Service—Cell Broadcast which allows for messages to be sent to all mobile users in a specified group in a specified geographical area. The advantage when associated with a Local Area Network (LAN) allows from a plurality of reception units to receive the same SMS message without the need to use a parser table with destination addresses.

Transmission of SMS messages under GSM 03.38 protocol is done using the Mobile Application MAP (MAP) of the SS7 protocol to transmit between a SMSC and the unit. Messages are sent with the MAP MO- and MT-FORWARDSM operations. The payload length is limited for example in this format to 140 octets or 1120 bits of information. A variety of alphabets can be used to encode, for example the default GSM 7-bit alphabet, the 8-bit data alphabet, and the 16-bit UTF/16UCS-2 alphabet based on the handset used. For 7-bit character alphabets, only 160 characters can be sent, for 8-bit character alphabets 140 characters can be sent and only 70 characters can be sent for each message using a 16-bit character alphabet. For example, complex languages such as Arabic, Chinese, Korean, Japanese, or Cyrillic require 16 bit encoding.

In one embodiment, the LONG-SMS concatenated SMS system can be use to send longer messages. These messages will start with User Data Header (UDH) containing segmentation information thus reducing the useful size of the messages to 153 characters for 7-bit encoding, 134 characters for 8-bit encoding, and 67 characters for 16-bit encoding. The LONG-SMS standard then allows for up to 255 segment encoding for a total length of the message of 39 k for 7-bit encoding, 34 k for 8-bit encoding, and 17 k for 16-bit encoding.

FIG. 2 from the prior art illustrates a sample communication stream where an originating source such as for example a computer, a telematics device, a portable phone, or any other equally functional device is located to the left of the figure and a destination source also either a computer, a telematics device, a portable phone, or any other equally functional device is located at the right of the device. In the center, a Short Message Service Center (SMSC) is the main key relay component including an actual Service Center (SC), an InterWorking Message Service Center (IW MSC), and a Gateway Message Service Center (G MSC).

During a submission, the device shown on the left sends the message to a Serving MSC or SGSN who in turn sense a MO-FORWARD SM to IW MSC. The message is then sent to the SC before it is sent to the G MSC before it is sent to a Serving MSC or SGSM before it is finally sent to the device. In the process of sending to the device, the Gateway MSC will obtain information from the Home Location Register (HLR) by sending a service package and obtaining routing information. The same way, the Serving MSC or SGSM will ask a Visitor Location Register (VLR) before instigating a page request. The acknowledgement message (ACK) is then returned to the device 1 using the same process as described above without the need to access the VLR or the HLR.

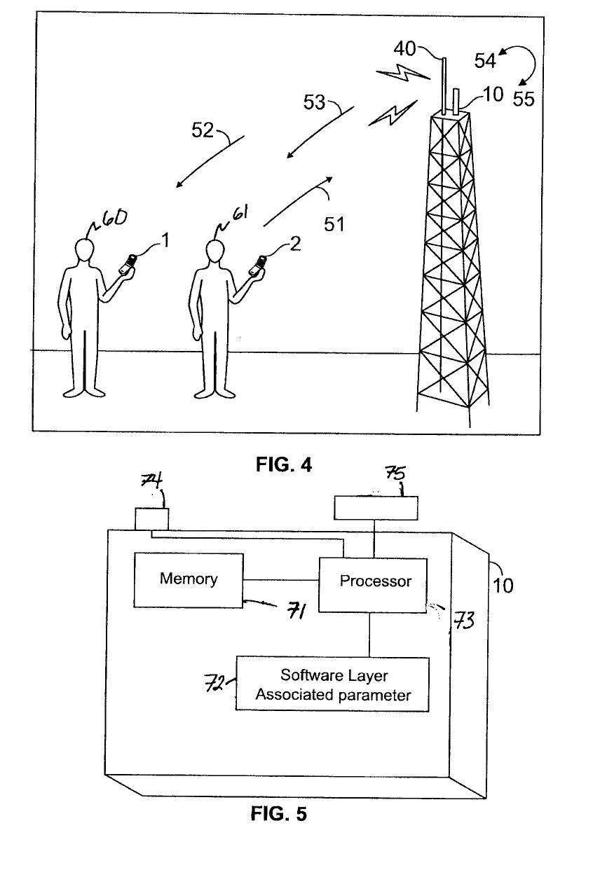

Turning now to an SMS communication platform 100 as illustrated on FIGS. 3, and 4. The platform 100 includes a messaging enabled emitter device 1 for sending a first SMS communication illustrated by the arrow 51 to a telematics device 10 by wireless communication via at least a wireless network 40. The arrows shown on FIGS. 3, and 4 can for example correspond to the data communication structure shown by FIG. 2.

The platform 100 includes on the back end at least one messaging enabled receiver 2 such as, for example, a cell phone, a personal digital assistant, a computer, or any other device in wireless communication with the network 40. The messaging enabled receiver 2 includes a software interface such as, for example, a Mobile Application Part (MAP) in the device for receiving a second SMS communication 53 from the telematics device 10 via the wireless network 40. By using the platform 100, a first user 60 shown on FIG. 4 types in a first SMS communication that is then sent up to the wireless network 40 and then sent back to the telematics device 10. The telematics device 10 using a software adaptation layer 72 as shown on FIG. 5, is equipped to decode a SMS communication, execute a wide range of operations using the SMS communication content as the input instructions in the software, for performing a function at the telematics device 10.

The software adaptation layer 72 as shown on FIG. 5 operates with a processor 73 connected to a memory 71 where the software is stored and operates with the use of the processor. While the software layer 73 is shown as a different component, the software layer contemplated is a level 7 layer that operates as an executable program in memory. The telematics device 10 as shown also includes an external port 74 such as an USB port, and a wireless emitter/receiver 75 to communicate with the network 40.

The telematics device 10 also includes a wireless communication port 75 for two way communication with the wireless network 40, a software adaptation layer 72 for executing the short message protocol, for receiving the first SMS communication 51 via the wireless network 40, and for creating the second SMS communication 54 using the software adaptation layer 72.

In one embodiment, the wireless network 40 includes a SMSC, at least a SGSN/Serving MSC, a VLR, and a HLR as steps within the process of the transportation and communication of the first and second SMS communications 51,53. The wireless network may be, for example, a cellular network or a satellite network. The SMSC can also include a SC, a IW MSC, and a Gateway MSC. While one known embodiment or communication structure is shown, what is contemplated is the use of any communication protocol, data structure, to send a short string of characters using existing wireless communication networks.

In one embodiment, the first SMS communication 51 includes a request for control data to the telematics device 10. In this case, the second SMS communication 54 created by the software adaptation layer 72 includes control data from the telematics device 10. The telematics device also may include a memory 71 for storing a specific data or even control data of the telematics device 10. In another embodiment, the first SMS communication 51 may include a request for the specific data stored in memory 71. The second SMS communication 53 created by the software adaptation layer 72 can also be made to include the specific data or even the control data. In the same way, the first SMS communication 51 may include at least a parameter directed information, and the software adaptation layer 72 may use at least a parameter directed information to reconfigure an associated parameter in the memory 71.

In yet another embodiment, the first SMS communication 51 includes a at least a parameter directed information, and the software adaptation layer 72 uses the at least a parameter directed information to modify an associated parameter in the memory 71. The associated parameter can be, for example, a reporting period, a sensor threshold, a call back number, or even an IP address.

Data used by telematics devices include control data, specific data, or even parameter directed information. Control data is used to control the different portions of the telematics device. Specific data is information collected by the telematics device and stored in memory, such as, for example, a sensor reading, and the parameter information is a value used by the telematics device to parameter an element, for example a sensitivity value for a sensor.

In a preferred embodiment, the first SMS communication 51 includes at least a recipient address, such as a phone number for the messaging enabled receiver 2 for directed the software adaptation layer 72 for sending the second SMS communication 53 to at least one of the messaging enabled receiver device 2 via the wireless network 40. In another embodiment, the first SMS communication 51 includes a coded character recognized by the software adaptation layer 72 for returning a positive confirmation message. The first and the second SMS communications 51, and 53, respectively, may be sent using a secure SMS messaging protocol or a LONG-SMS concatenated SMS system.

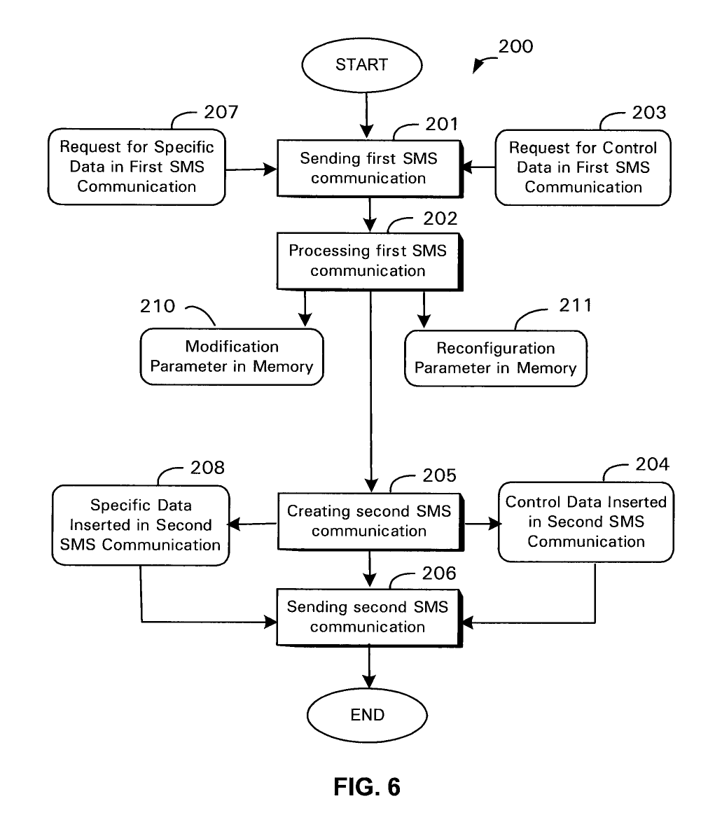

FIG. 6 discloses a method for collecting information from a telematics device 200 using a messaging enabled emitter device 1, and at least one messaging enabled receiver device 2. The method is shown as sending 201 via the messaging enabled emitter device 1 a first SMS communication 51 to a telematics device 10 by wireless communication via at least a wireless network 40, then processing 202 at the telematics device 10 the first SMS communication 51, where the telematics device 10 includes a wireless communication port 55 for two way communication with the wireless network 40, a software adaptation layer 72 for executing the short message protocol, for receiving the first SMS communication 51 via the wireless network 40, and then creating 205 a second SMS communication 53 using the software adaptation layer 72. The second SMS communication 53 can then be sent 206 to at least one messaging enabled receiver device 2 for receiving the second SMS communication 53 from the telematics device 10.

As stated above, the first SMS communication 51 may include a request for control data 203 to the telematics device 10, and the second SMS communication created 204 by the software adaptation layer may include control data from the telematics device. In another embodiment, the first SMS communication 51 includes a request for the specific data 207, and the second SMS communication 53 created by the software adaptation layer 72 includes the specific data 208.

The method also relates to a method for sending control data to a telematics device 10 and receiving a confirmation message of the control data from the telematics device 10 using a messaging enabled emitter device 1 and an enabled receiver device 2. The method includes sending 201 via the messaging enabled emitter device 1 a first SMS communication 51 to a telematics device 10 by wireless communication via at least a wireless network 40. Processing 202 at the telematics device 10 the first SMS communication 51, where the telematics device 10 includes a wireless communication port 75 for two way communication with the wireless network 40, a software adaptation layer 72 for executing the short message protocol, for receiving the first SMS communication 51 via the wireless network 40, and creating 205 a second SMS communication 53 using the software adaptation layer 72. Finally, the method is directed to sending 206 to at least one messaging enabled receiver device 2 for receiving the second SMS communication 53 from the telematics device 10. When the first SMS communication 51 includes at least a parameter directed information, the software adaptation layer 72 uses at least a parameter directed information to reconfigure 211 of an associated parameter in the memory. When the first SMS communication 51 includes at least a parameter directed information, the software adaptation layer 72 uses at least a parameter directed information to modify 210 an associated parameter in the memory.

In one embodiment, commands are exchanged between a portable cell phone used as the messaging enabled emitter device 1 and a second portable cell phone used as the enabled receiver device 2. The software adaptation layer 72 receives or emits the message as a string of 140 bytes or binary code of 160 characters.

In one contemplated embodiment, SMS messages are sent as a string of characters to and from the adaptation layer 72. First, a message type is defined, such as, for example, 0 for communication with the telematics device 10. A message ID is then connected to the message type where for example a SMS Event Message corresponds to a message ID of 30, a SMS Diagnostics Message corresponds to a message ID of 31, a SMS Configuration Parameter Message corresponds to a message ID of 33, and a SMS Debugging Message corresponds to a message ID of 35. While the numbers 30, 31, 33, and 35 are taken for different message ID numbers, what is contemplated is the use of any number or character from 0 to F in the hexadecimal character set.

Next, a third number is placed in the string of characters as a mode of operation (0 for read, 1 for write). If an incoming message to the adaptation layer 72 has a 1 as this binary character, then a parameter value is expected for a change in the parameter value. If the incoming message has a 0 as this binary character, then no parameter value is expected or read. Third, the sender phone number is sent preceded by a hexadecimal character indicating the length in hexadecimals of the phone number received from the sender. Finally, for write messages, a parameter value is attached to the last portion of the string.

The following table lists the contemplated parameter ID in hexadecimal characters along with a brief description of one possible use of the parameter along with the parameter value expected in a write message to override the value in the memory returned in a read message:

| | |
|---|---|
| Parameter ID | |
| (hexadecimal) | Parameter Value |

| ID | Description | (decimal) |
|---|---|---|
| 01 | Parameter #1 | 0-86399 |
| 02 | Parameter #2 | 0-30 |
| 03 | Parameter #3 | 1-255 |
| . . . | . . . | . . . |

The above table is only illustrative of how different parameter IDs can be encoded within different SMS character strings. For example, if the string 0330A660111222201 is received , the 0 is for the type of message, 33 stands for SMS Configuration Parameter Message ID, 0 for if a read only message, A stands for a phone number having a length of 10 (A=10 in hexadecimal), 6301112222 is the ten-digit phone number, and finally, 01 is for reading the value of Parameter #1. In such a case, the adaptation layer 72 will read this value stored in memory of the telematics device 10 and send back a message to the given phone number associated with the value. The decoding of an incoming message to the sender is made along the same lines. A string of characters such as the description of the parameter ID can be attached to the value to provide the sender with the following message: “Parameter #1 value=61234.”

In the above table, a plurality of different variables are listed for one possible embodiment. While certain parameters are listed, the use of this structure to send and receive any type of information, either binary or characters from the telematics device 10, is contemplated. In another illustrative example, the following string is received via SMS: 0331A6311122220115. Since the value before the A this time is 1, the mode is on write. The message requests the update of the Parameter #1 with the value 15. Accordingly, the adaptation layer 72 will override the currently existing value in memory with the value 15. In the contemplated embodiment, a confirmation SMS message is sent back to the sender phone as described above. To send an unsupported character in SMS character set, a character may be replaced with another character such as, for example, a comma for “@.”

What is also contemplated is the use of SMS messaging to help with system debugging phases. During these phases, communications must be sent to a user or programmer to provide him or her with information as to the different operating modules within the adaptable layer 72. Based on these text messages, the programmer may then interact with the telematics device 10 by uploading a SMS message requesting the information (Mode 0), or by either enabling or disabling the function or module as part of the adaptable layer 72. A debug flag (see below on table) replaces the parameter value.

The following table lists, for example, the contemplated parameter ID in hexadecimal characters along with a brief description of one possible module ID/variable ID to be debugged and a binary value for the module ID/variable ID for the enablement or parameter:

| | |
|---|---|
| Module ID/Variable ID | |
| (hexadecimal) | Debug flag |

| ID | Description | (decimal) |
|---|---|---|
| 01 | Reserved | 0 - Enable |
| 02 | ADC | 1 - Disable |
| 03 | CFG | |
| 04 | Reserved | |
| 05 | Communication Manager | |
| 06 | EventData | |
| 07 | GPS Communication | |
| 08 | Reserved | |
| 09 | Module info | |
| 0A | Reserved | |
| 0B | Garbage Collector | |
| 0C | GPS Processing | |
| 0D | Reserved | |
| 0E | Scheduler | |
| 0F | SMS service | |

By sending a string 0351A6301112222031, the message type is 0, the message ID is 35 corresponding to a SMS Debug Message, the mode 1 corresponds to write, the letter A is for 10 characters sent for the sender's phone number (e.g., 6301112222), and the module 03 (the CFG in this example) is then enabled with the parameter 1. Again, a confirmation SMS is then sent back to the sender for confirmation.

In yet another embodiment, when a simple SMS Event Message is sent, using Message ID 30, a report is sent back to the sender's phone number. An second report may also be sent to a host along with the report back to the sender. In yet another embodiment, when a SMS Diagnostic Message is sent using Message ID 31, the unit serial number and the software version is then returned to the sender. While four possible message IDs are listed along with detailed descriptions of how they interface with the adaptable layer 72, any type of communication between the telematics device 10 and the receiver and emitter devices 1, 2 is contemplated.

A telematics device 10 having a wireless modem, a GPS device, and at least a sensor. This layer is capable of collecting data for a plurality of predefined events. The occurrence of these events is then stored in real time memory as, for example, a flash file system as part of a database. These records may be transmitted to a host server (not shown) wherever a wireless communication link is activated or established. Once a host server acknowledges a reception of the record, the device may erase the value from the flash file. In one preferred embodiment, the telematics device 10 may report to the host at an interval of 1 to 2 hours.

It is understood that the preceding detailed description of some examples and embodiments of the present invention may allow numerous changes to the disclosed embodiments in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. An SMS communication platform, comprising:
a messaging enabled emitter device for sending a first SMS communication to a telematics device by wireless communication via at least a wireless network;
at least one messaging enabled receiver device for receiving a second SMS communication from the telematics device by wireless communication via at least the wireless network;
wherein the telematics device includes a wireless communication port for two way communication with the wireless network, a software adaptation layer for executing the short message protocol, for receiving the first SMS communication via the wireless network and for creating the second SMS communication using the software adaptation layer.

2. The SMS communication platform of claim 1, wherein the wireless network includes a SMSC, at least a SGSN/Serving MSC, a VLR, and a HLR.

3. The SMS communication platform of claim 1, wherein the wireless network is selected from a group consisting of a cellular network, and a satellite network.

4. The SMS communication platform of claim 2, wherein the SMSC further includes a SC, a IW MSC, and a Gateway MSC.

5. The SMS communication platform of claim 1, wherein the first SMS communication includes a request for control data to the telematics device, and wherein the second SMS communication created by the software adaptation layer includes control data from the telematics device.

6. The SMS communication platform of claim 1, wherein the telematics device includes a memory for storing a specific data of the telematics device, wherein the first SMS communication includes a request for the specific data, and wherein the second SMS communication created by the software adaptation layer includes the specific data.

7. The SMS communication platform of claim 6, wherein the first SMS communication includes at least a parameter directed information, and wherein the software adaptation layer uses the at least a parameter directed information to reconfigure an associated parameter in the memory.

8. The SMS communication platform of claim 6, wherein the first SMS communication includes at least a parameter directed information, and wherein the software adaptation layer uses at least a parameter directed information to modify an associated parameter in the memory.

9. The SMS communication platform of claim 7, wherein the associated parameter is selected from a group consisting of a reporting period, a sensor threshold, a call back number, and an IP address.

10. The SMS communication platform of claim 1, wherein the first SMS communication includes at least a recipient address for directed the software adaptation layer for sending the second SMS communication to at least one of the messaging enabled receiver device via the wireless network.

11. The SMS communication platform of claim 10, wherein at least one messaging enabled receiver device for receiving a second SMS communication is a hand held cell phone and the recipient address is a phone number.

12. The SMS communication platform of claim 1, wherein the first SMS communication includes a coded character recognized by the software adaptation layer for returning a positive confirmation message from a recipient selected from the group of the telematics device and the at least one messaging enabled receiver.

13. The SMS communication platform of claim 1, wherein the first and the second SMS communications are sent using a secure SMS messaging protocol.

14. The SMS communication platform of claim 1, wherein either of the first and the second SMS communications are sent using a LONG-SMS concatenated SMS system.

15. A method for collecting information from a telematics device using a messaging enabled emitter device, and at least one messaging enabled receiver device, the method comprising the steps of:
sending via the messaging enabled emitter device a first SMS communication to a telematics device by wireless communication via at least a wireless network;
processing at the telematics device the first SMS communication, wherein the telematics device includes a wireless communication port for two way communication with the wireless network, a software adaptation layer for executing the short message protocol, for receiving the first SMS communication via the wireless network;
creating a second SMS communication using the software adaptation layer; and
sending to at least one messaging enabled receiver device the second SMS communication from the telematics device.

16. The method of claim 15, wherein the wireless network is selected from a group consisting of a cellular network, and a satellite network.

17. The method of claim 15, wherein the first SMS communication includes a request for control data to the telematics device, and wherein the second SMS communication created by the software adaptation layer includes control data from the telematics device.

18. The method of claim 15, wherein the telematics device includes a memory for storing a specific data of the telematics device, wherein the first SMS communication includes a request for the specific data, and wherein the second SMS communication created by the software adaptation layer includes the specific data.

19. A method for sending control data to a telematics device and receiving a confirmation of the control data from the telematics device using a messaging enabled emitter device, and at least one messaging enabled receiver device, the method comprising the steps of:
sending via the messaging enabled emitter device a first SMS communication to a telematics device by wireless communication via at least a wireless network;
processing at the telematics device the first SMS communication, wherein the telematics device includes a wireless communication port for two way communication with the wireless network, a software adaptation layer for executing the short message protocol, for receiving the first SMS communication via the wireless network;
creating a second SMS communication using the software adaptation layer; and
sending at least one messaging enabled receiver device for receiving the second SMS communication from the telematics device.

20. The method of claim 19, wherein the first SMS communication includes at least a parameter directed information, and wherein the software adaptation layer uses at least a parameter directed information in a step of reconfiguration of an associated parameter in the memory.

21. The SMS communication platform of claim 19, wherein the first SMS communication includes at least a parameter directed information, and wherein the software adaptation layer uses at least a parameter directed information in a step to modify an associated parameter in the memory.
